(19) United States
(12) Patent Application Publication
(10) Pub. No.: US 2012/0291868 A1
(43) Pub. Date: Nov. 22, 2012

(54) WATER HEATING DEVICE

(76) Inventor: DROR GILADI, Ganey Tikva (IL)

(21) Appl. No.: 13/468,051

(22) Filed: May 10, 2012

(30) Foreign Application Priority Data
May 19, 2011 (IL) 213011

(51) Int. Cl. F24J 2/00; F24H 9/02

(52) U.S. Cl. 137/1; 137/561 R; 126/569

(57) ABSTRACT

In one aspect, the present invention is directed to a heating device comprising: a heating container (10, 12); an inlet (40, 72), through which water to be heated enters the heating container (10, 12), the inlet being disposed at a lower portion of the container (10,12); a first outlet (62, 74), through which water heated within the heating container (10,12) exits thereof, the first outlet drawing water from a high portion of the container (10, 12); and a second outlet (44, 22) for drawing water from a low portion of the container (10, 12), the second outlet being openable for releasing therethrough water including accumulated scale, thereby enabling discarding scale when accumulated in the container (10, 12).

### FIELD OF THE INVENTION

The present invention relates to the field of water boilers and solar collectors. More particularly, the invention relates to a method and apparatus for discarding scale from these devices.

### BACKGROUND OF THE INVENTION

One of the periodic maintenances of water boilers includes disassembling the flange thereof, including the heater, for discarding scale.

However, scale attaches to the metal elements when not discarded immediately.

All the methods described above have not yet provided satisfactory solutions to the problem of accumulated scale.

It is an object of the present invention to provide a method and apparatus for discarding scale from water boilers and from solar collectors.

It is an object of the present invention to provide a. solution to the above-mentioned and other problems of the prior art.

Other objects and advantages of the invention will become apparent as the description proceeds.

### SUMMARY OF THE INVENTION

In the figures and/or description herein, the following reference numerals have been mentioned:
numeral 10 denotes a water boiler according to one embodiment of the present invention;
numeral 12 denotes a solar collector according to one embodiment of the present invention;
numerals 14 and 16 denotes water pipes;
numeral 18 denotes a processor or a timer;
numeral 22 denotes an outlet or a faucet of a solar collector;
numeral 24 denotes a pipe for releasing scale out of a solar collector;
numeral 34 denotes wired communication to a faucet of the boiler;
numeral 30 denotes a faucet for opening an outlet for discarding scale;
numeral 32 denotes a pipe;
numeral 28 denotes wired communication to a faucet of the solar collector;
numeral 36 denotes a water outlet;
numeral 38 denotes an outlet of a boiler for supplying cold water to a solar collector;
numeral 40 denotes a water inlet;
numeral 42 denotes a cover;
numeral 44 denotes a water outlet;
numeral 46 denotes a heating element;
numeral 48 denotes a heat-accelerating sleeve;
numeral 50 denotes a thermostat;
numeral 54 denotes an aperture of a heating accelerator sleeve;
numeral 56 denotes the interior shell of a boiler;
numeral 58 denotes the exterior shell of a boiler;
numeral 60 denotes an inlet of a boiler for receiving boiler water from a solar collector;
numeral 62 denotes an inlet;
numeral 64 denotes an outlet;
numeral 66 denotes heat isolation of a boiler;
numeral 68 denotes a flange of the boiler, for allowing disassembling the heating element;
numeral 70 denotes a pipe;
numeral 72 denotes an inlet of the inlet piping of the solar collector:
numeral 74 denotes an outlet of the inlet piping of the solar collector; and
numeral 80 denotes a vertical pipe within the boiler.

In one aspect., the present invention is directed to a heating device, comprising:
a heating container (10, 12);
an inlet (40, 72), through which water to be heated enters the heating container (10, 12), the inlet being disposed at a low portion of the container (10,12);
a first outlet (62, 74), through which water heated. within the heating container (10,12) exits thereof, the first outlet drawing water from a high portion of the container (10, 12); and
a second outlet (44, 22) for drawing water from a lower portion of the container (10, 12), the second outlet being openable for releasing therethrough water including accumulated scale,
thereby enabling discarding scale when accumulated in the container (10, 12).

The water heating device may further comprise:
a faucet (30, 22) for opening and closing the second outlet (44, 22).

The water heating device (10, 12) may further comprise
a controller (18) for automatically controlling the opening and closing of the faucet (30, 22), to discard scale with an insignificant waste of water.

According to one embodiment, the water container (10, 12) may comprise a water boiler (10).

According to another embodiment, the container (10, 12) may comprise internal piping of a solar collector (12).

The second outlet (44) may be disposed on a flange of the water boiler (10).

The water heating device may further comprise:
a pipe (70) extending from a volume of a heat accelerating sleeve (48); according to this embodiment, the second outlet (44) is disposed outside the sleeve (48), and
the pipe (70) extends to the second outlet (44), thereby the pipe (70) draws scale from the volume of the heat accelerating sleeve (48) outside to the second outlet (44).

In another aspect, the present invention is directed to a heating method, comprising the steps of
providing a heating container (10, 12);
providing a first outlet (62, 74), through which water heated within the heating container (10,12) exits thereof, the first outlet being disposed at a high portion of the container (10, 12);
providing a second outlet (44, 22) disposed at a lower portion of the container (10, 12);
opening the second outlet (44, 22) from time to time for releasing therethrough water including accumulated scale,
thereby enabling discarding scale when accumulated in the container (10, 12).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 is a cross-sectional view of a water boiler according to one embodiment of the present invention.

FIG. 2 depicts a flange including the scale outlet of FIG. 1.

FIG. 3 is a cross-sectional view of a water boiler according to another embodiment of the present invention.

FIG. 4 is a cross-sectional. view of a water boiler according to another embodiment of the present invention.

FIG. 5 depicts the water boiler of FIGS. 1 to 3 from the bottom.

FIG. 6 depicts scale discarding in a solar collector.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

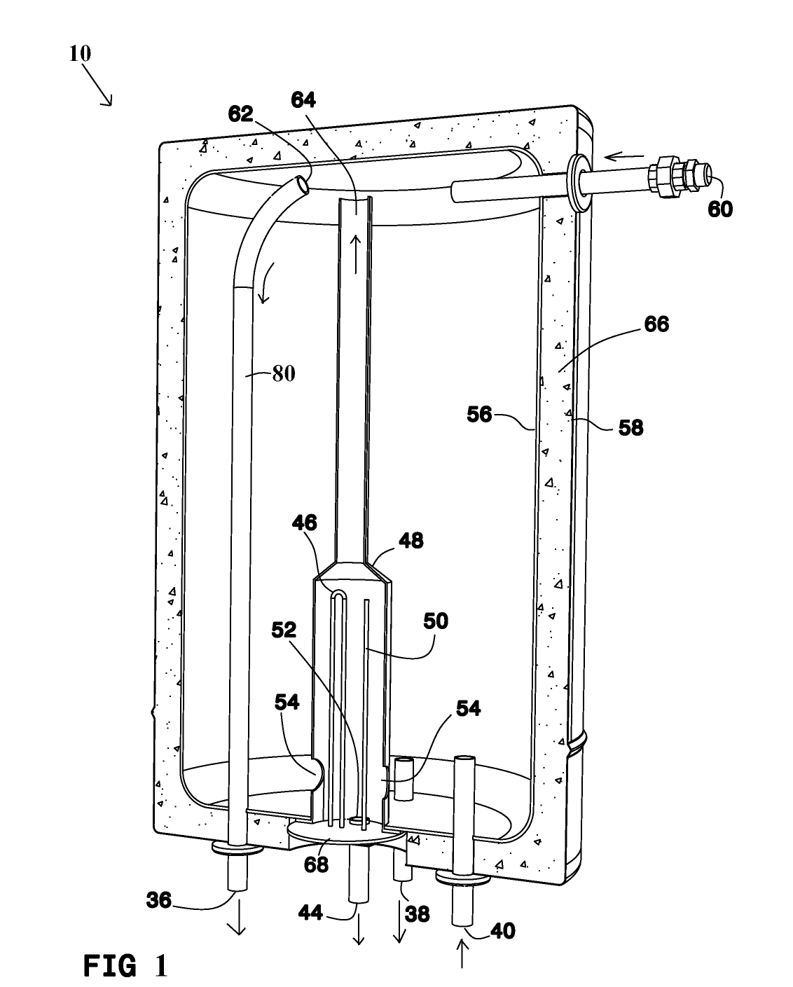

FIG. 1 is a cross-sectional view of a water boiler, according to one embodiment of the present invention.

Like prior art water boilers, the water boiler 10 of FIG. 1, being a container, includes a cold water inlet 40 and a warm water outlet 36, both at the bottom of boiler 10. Water is heated either by a heating element 46 entering through apertures 54 into a heat-accelerating sleeve 48 and rising to the top outlet 64 thereof, or by a solar collector supplying the water to inlet 60 at the top of boiler 10. The heated water thus is concentrated at the top of boiler 10, and flows from an inlet 62 of a vertical pipe 80 to warm water outlet 36.

Unlike prior art water boilers, water boiler 10 of FIG. 1 includes an outlet 44 at the bottom thereof for releasing scale therethrough.

Outlet 44 when opened releases relatively unwarmed water, and thus is not suitable for supplying the heated water. Thus, outlet 44 is opened only for short periods from time to time, for flowing limited amounts of water, for releasing scale concentrated there, before attaching the metal elements, without wasting significant amounts of water.

Outlet 44 preferably is disposed close to the bottom of the heating element 46, which typically produces scale.

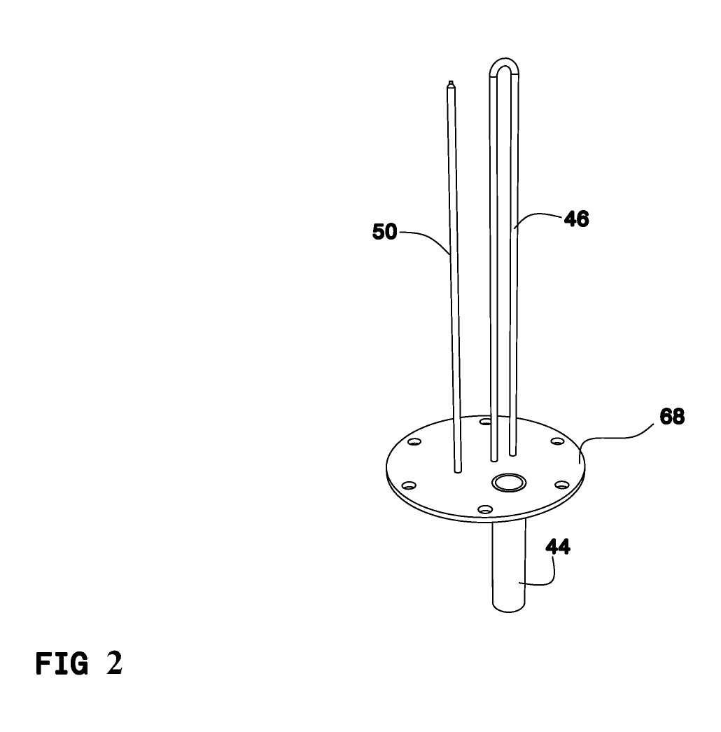

FIG. 2 depicts a flange including the scale outlet of FIG. 1.

Installation of outlet 44 to an existing boiler according to this embodiment requires only replacing the flange 68 including the heating element 46 and the thermostat 50.

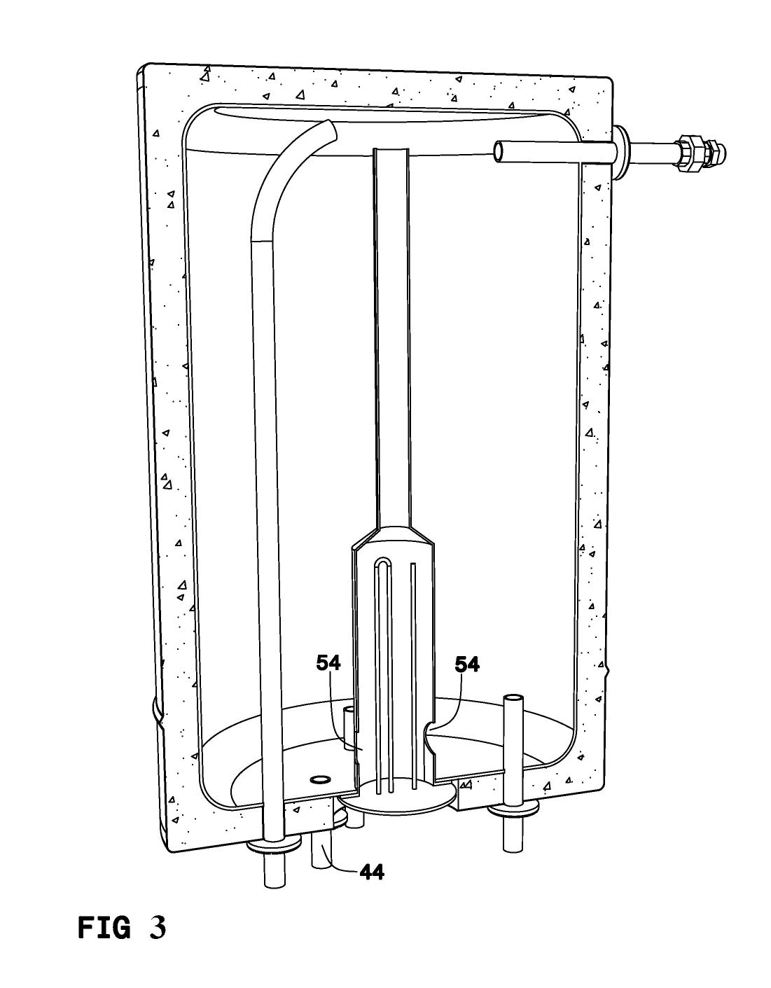

FIG. 3 is a cross-sectional view of a water boiler according to another embodiment of the present invention.

According to another embodiment, outlet 44 is disposed elsewhere at the bottom of boiler 10. This embodiment is suited especially for solar heating, where the heating element is less active.

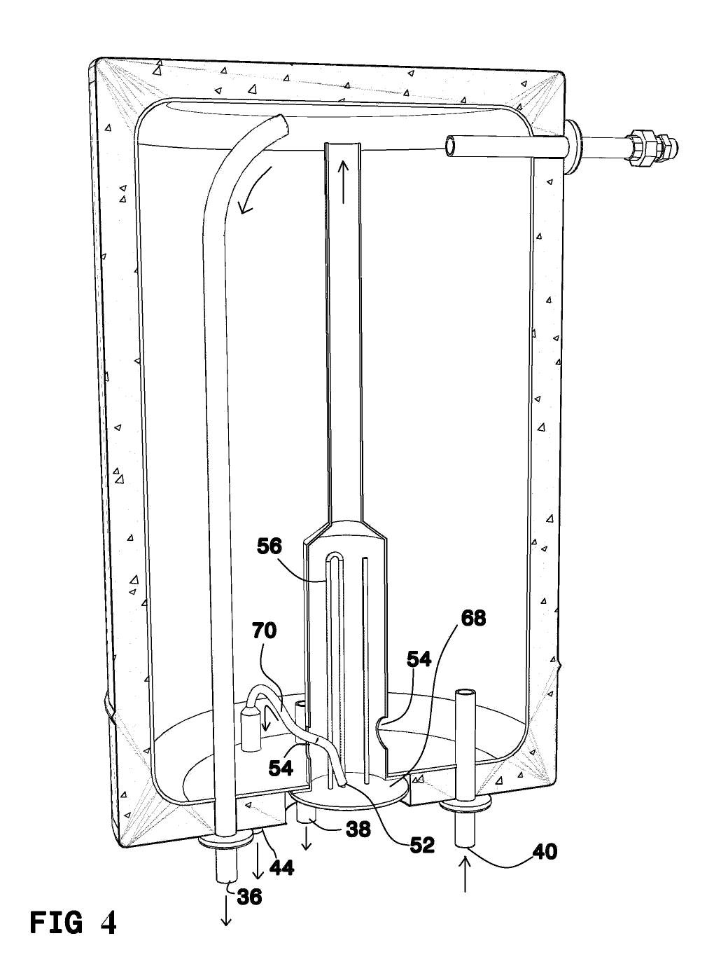

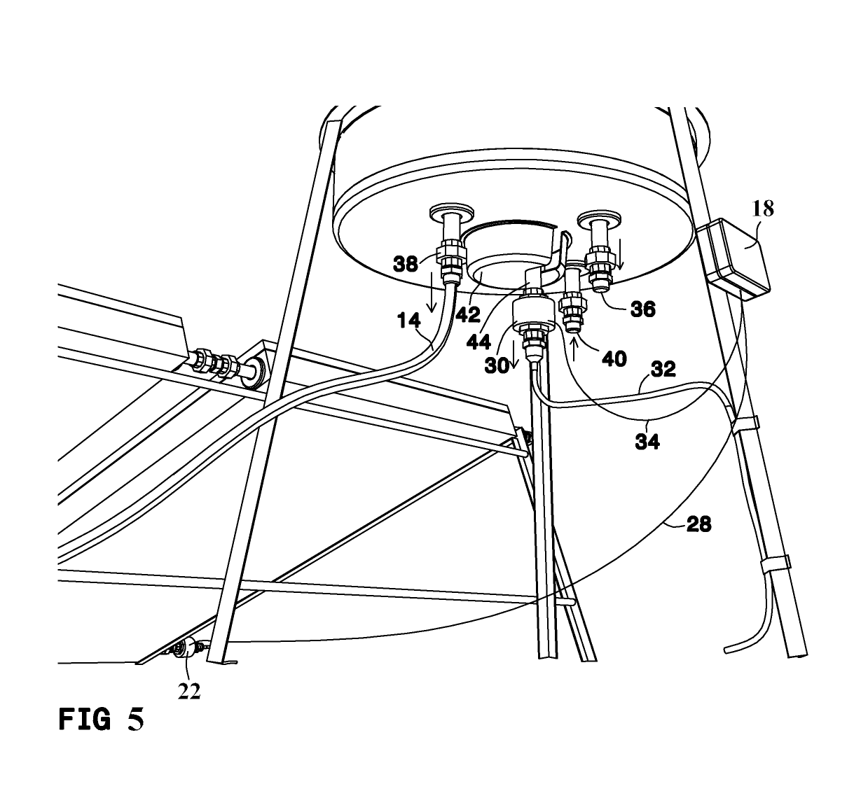

FIG. 4 is a cross-sectional view of a water boiler according to another embodiment of the present invention.

According to another embodiment, a pipe 70 may draw the scale from the bottom of the heating element 46 towards outlet 44. Pipe 70 may extend through apertures 54.

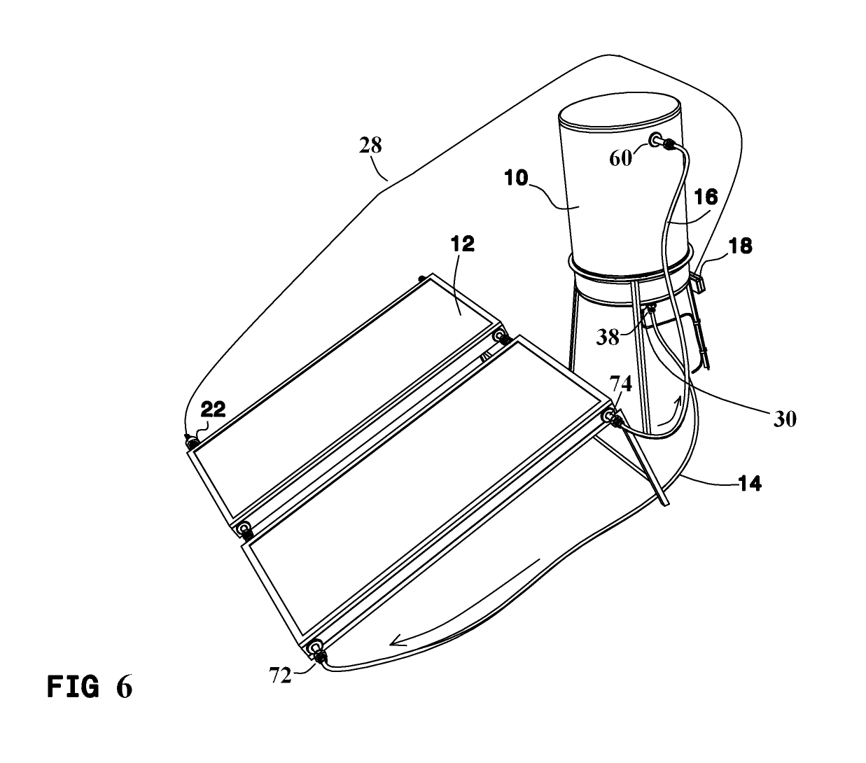

FIG. 5 depicts the water boiler of FIGS. 1 to 3 from the bottom.

Scale outlet 44 is opened by a faucet 30 temporally, for short periods, from time to time. Water and scale are released to a pipe 32 upon opening faucet 30, due to the network water pressure within boiler 10.

Faucet 30 may be an electric faucet, controlled manually or by a controller 18, which may be a timer, or a processor, via wired communication 34 or wireless communication.

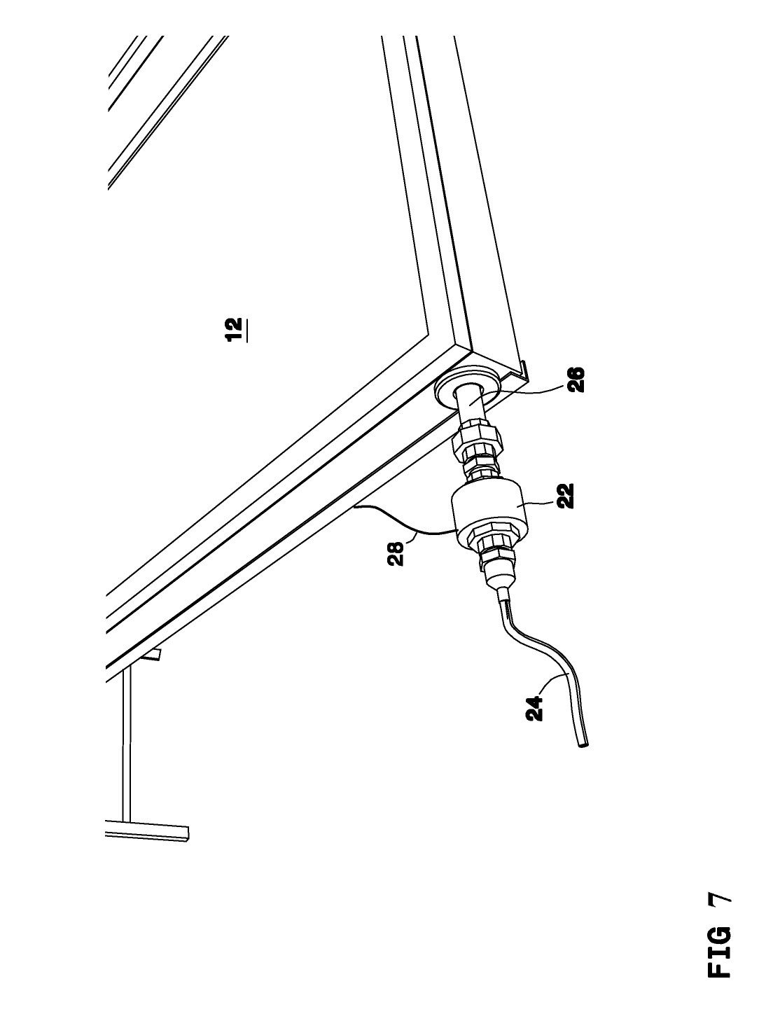

FIG. 6 depicts scale discarding in a solar collector.

FIG. 6 depicts cold water exiting outlet 38 of boiler 10 and entering, via a pipe 14, an inlet 72 of an internal piping (not shown) of a solar collector 12 at the bottom thereof. The internal piping of solar collector 12, in which water flows, may be regarded as a water container.

Water heated by the sun exits via an outlet 74 of the internal piping of solar collector 12 at the top thereof enter, via a pipe 16, into inlet 60 of boiler 10 at the top thereof.

A faucet 22, being another outlet of the piping of solar collector 12 at the bottom thereof, opens temporally for short periods from time to time, for releasing water and discarding mixed scale, which naturally sinks to the bottom of the internal piping of collector 12.

Faucet 22 may constitute a manual faucet, or an electric faucet, controlled manually or by a timer, or by processor 18 via wired communication 28, or wireless communication.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A heating device comprising:
a heating container (10, 12);
an inlet (40, 72), through which water to be heated enters said heating container (10, 12), said inlet being disposed at a low portion of said container (10,12);
a first outlet (62, 74), through which water heated within said heating container (10,12) exits thereof, said first outlet drawing water from a high portion of said container (10, 12); and
a second outlet (44, 22) for drawing water from a lower portion of said container (10, 12), said second outlet being openable for releasing therethrough water including accumulated scale,
thereby enabling discarding scale when accumulated in said container (10, 12).

2. A water heating device according to claim 1, further comprising:
a faucet (30, 22) for opening and closing said second outlet (44, 22).

3. A water heating device (10, 12) according to claim 2, further comprising
a controller (18) for automatically controlling said opening and closing of said faucet (30, 22), to discard scale with an insignificant waste of water.

4. A water heating device according to claim 1, wherein said water container (10, 12) comprises a water boiler (10).

5. A water heating device according to claim 1, wherein said container (10, 12) comprises internal piping of a solar collector (12).

6. A water heating device according to claim 4, wherein said second outlet (44) is disposed on a flange of said water boiler (10).

7. A water heating device according to claim 4, further comprising:
a pipe (70) extending from a volume of a heat accelerating sleeve (48),
and wherein said second outlet (44) is disposed outside said sleeve (48), and
wherein said pipe (70) extends to said second outlet (44), thereby said pipe (70) draws scale from said volume of said heat accelerating sleeve (48) outside to said second outlet (44).

8. A heating method comprising the steps of
providing a heating container (10, 12);
providing a first outlet (62, 74), through which water heated within said heating container (10,12) exits thereof, said first outlet being disposed at a high portion of said container (10, 12);
providing a second outlet (44, 22) disposed at a lower portion of said container (10, 12);
opening said second outlet (44, 22) from time to time for releasing therethrough water including accumulated scale,
thereby enabling discarding scale when accumulated in said container (10, 12).
